(19) United States
(12) Patent Application Publication
(10) Pub. No.: US 2022/0409935 A1
(43) Pub. Date: Dec. 29, 2022

(54) AIR RESPIRATOR AND FIREPROOF CLOTHING WORN WITH AIR RESPIRATOR

(71) Applicant: KOKEN LTD., Tokyo (JP)

(72) Inventor: Daishi SATO, Chiyoda-ku, Tokyo (JP)

(21) Appl. No.: 17/777,623

(22) PCT Filed: Nov. 12, 2020
(86) PCT No.: PCT/JP2020/042194

§ 371 Date: May 18, 2022

(30) Foreign Application Priority Data
Nov. 19, 2019 (JP) 2019-209142
Feb. 10, 2020 (JP) 2020-020697

(51) Int. Cl. A62B 17/00; A62B 7/02

(52) U.S. Cl. CPC A62B 17/003; A62B 7/02

(57) ABSTRACT

A back carrier of an air respirator includes a cooling conduit section having a meandering metal conduit. The cooling conduit section is interposed between a branching port having a pressure reducing valve built in and a medium-pressure hose. Breathable gas that is filled in a cylinder at high pressure, and adiabatically expanded via the pressure reducing valve flows into the cooling conduit section so as to exert a cooling effect around the cooling conduit section. Such an air respirator can be used for protective clothing and also for fireproof clothing.

### RELATED APPLICATIONS

The present application is a National Phase of International Application Number PCT/JP2020/042194, filed Nov. 12, 2020, which claims priority to Japanese Application Nos. 2019-209142, filed Nov. 19, 2019 and 2020-020697, filed Feb. 10, 2020.

### TECHNICAL FIELD

The present invention relates to an air respirator and fireproof clothing worn with the air respirator, more particularly, to an air respirator capable of exerting a cooling effect on a wearer of the air respirator and fireproof clothing worn with the air respirator.

### BACKGROUND

Air respirators worn by workers at construction sites, disaster sites, or the like are conventionally well-known. Protective clothing and fireproof clothing worn by the workers along with the air respirators are also well-known. The protective clothing used here is worn for work involving chemical substances or work at sites involving dust or odor generated, and the fireproof clothing is worn for fire fighting operations, for example. It is also widely known that heat stroke preventive measures should be taken for the workers wearing the air respirators, protective clothing, or fireproof clothing.

For example, there is a technique for sending outside air or cool wind into a space between the protective clothing and the wearer by a fan attached to the protective clothing. However, the technique for sending the outside air can not be used when a temperature of outside air is high, or the outside air contains toxic substances. Moreover, the technique using the cool wind requires an additional device for supplying the cool wind apart from the air respirator.

For example, cooling protective clothing disclosed in Japanese Unexamined Patent Application Publication No. 2003-27312 (Patent Literature 1) includes a gas supply means, a first conduit extending from the gas supply means to be connected to a breathing apparatus, and a branching connector disposed on the first conduit for branching gas. The gas branched by the branching connector is led to a gas cooling means to be cooled. The cooled gas is led to a main body of the protective clothing via a second conduit extending from the cooling means. The protective clothing at least partly has a two-layer structure, and an inner layer of the two-layer structure includes a spouting hole formed for spouting the cooled gas toward a body. An area of activity of a worker wearing this cooling protective clothing is limited by a length of the first conduit extending from the gas supply means.

### CITATION LIST

### Patent Literature

Patent Literature 1: Japanese Unexamined Patent Application Publication No. 2003-27312

### SUMMARY OF THE INVENTION

### Technical Problem

An object of the present invention is to provide an air respirator that is free from limitations on an area of activity caused by a connection by piping to a cool gas generating device, and that can exert a cooling effect without limiting the area of activity of a wearer in spite of an absence of a portable cool gas generating device.

### Solution to Problem

In order to achieve the object, the present invention is directed to an air respirator including a cylinder containing breathable gas filled at high pressure, a back carrier, a pressure reducing valve, and a flexible medium-pressure hose. The back carrier, pressure reducing valve, and medium-pressure hose are used for the cylinder. In addition, another object is to provide fireproof clothing worn with the air respirator.

The air respirator includes following features according to the present invention. The back carrier includes a cooling conduit section where the gas coming from the cylinder and adiabatically expanded via the pressure reducing valve flows in a meandering metal conduit to exert a cooling effect around the conduit. The cooling conduit section is interposed between the pressure reducing valve and the medium-pressure hose.

According to an embodiment of the present invention, the conduit forming the cooling conduit section meanders by repeating any two or more of shapes including a curved shape, a bent shape, and a linear shape, and is in close contact with a cooling plate made of a material having a thermal conductivity of at least 2 W/m·K.

According to another embodiment of the present invention, the cooling plate includes a front surface configured to face the back of a wearer of the air respirator and a rear surface opposite to the front surface, and the cooling conduit section is in close contact with the rear surface.

According to still another embodiment of the present invention, the back carrier is disposed inside protective clothing worn by the wearer.

According to still another embodiment of the present invention, the back carrier is disposed inside the protective clothing worn by the wearer of the air respirator, includes a cooling box including a front plate section configured to face the back of the wearer, a rear plate section configured to face a back part of the protective clothing, a peripheral wall section interposed between the front plate section and the rear plate section, and a hollow section defined at least by the front plate section, the rear plate section, and the peripheral wall section. The cooling box includes at least two of ventilation elements including a ventilation hole, an intake blower, and an exhaust blower that are configured to allow ventilation between an inside and an outside of the hollow section accommodating the cooling conduit section so that the air at an inside or an outside of the protective clothing is allowed to flow into the hollow section.

According to still another embodiment of the present invention, the cooling box includes the ventilation hole and the intake blower. When the intake blower is in operation, the air at one of the inside or the outside of the protective clothing flows into the cooling box while the air inside the cooling box flows out toward the inside of the protective clothing through the ventilation hole.

According to still another embodiment of the present invention, the cooling box includes the ventilation hole and the exhaust blower. When the exhaust blower is in operation, the air inside the cooling box flows out while the air inside the protective clothing flows into the cooling box through the ventilation hole.

Still another embodiment of the present invention is fireproof clothing worn with the air respirator described in the paragraphs [0007] and [0008]. The conduit including the cooling conduit section is interposed between the pressure reducing valve and the medium-pressure hose, and includes a first end portion connected to the pressure reducing valve and a second end portion connected to the medium-pressure hose. The fireproof clothing includes an outer layer, an inner layer, and an intermediate layer interposed between the outer layer and the inner layer. The cylinder is disposed outside the outer layer, and the back carrier and the cooling conduit section are disposed inside the inner layer.

According to still another embodiment of the present invention, the cooling conduit section meanders by repeating any two or more of the shapes including the curved shape, the bent shape, and the linear shape, and is in close contact with the cooling plate made of a material having a thermal conductivity of at least 2 W/m·K The cooling plate is disposed inside the inner layer and includes the front surface configured to face the back of the wearer of the air respirator and the rear surface opposite to the front surface, and the cooling conduit section is in close contact with the rear surface.

### Advantageous Effects of Invention

An air respirator according to the present invention utilizes a phenomenon that a temperature of gas sharply drops by adiabatic expansion when high-pressure gas filled in a cylinder flows out of the cylinder to a metal conduit via a pressure reducing valve. A cooling conduit section formed of the conduit exerts a cooling effect on the surroundings. Such an air respirator can be used to give the cooling effect to a wearer. The air respirator can exert the cooling effect when it is worn with protective clothing, and when it is worn with fireproof clothing as well.

### BRIEF DESCRIPTION OF DRAWINGS

The drawings illustrate specific embodiments of the present invention pertaining to the present disclosure including optional and preferred embodiments as well as essential features of the invention.

FIG. 1 is a perspective view of an air respirator in a wearing state.

FIG. 2 is a plan view of the air respirator.

FIG. 3 is a partial cutaway perspective view of a back carrier.

FIG. 4 is a cross-sectional view taken along line IV-IV in FIG. 3.

FIG. 5 is a view similar to FIG. 1 according to an embodiment.

FIG. 6 is a partial cutaway view of FIG. 5.

FIG. 7 is a partial cutaway view of the back carrier of FIG. 6.

FIG. 8 is a cross-sectional view take along line VIII-VIII of FIG. 7.

FIG. 9 is a view similar to FIG. 8 according to an embodiment.

FIG. 10 is a view similar to FIG. 8 according to another embodiment.

FIG. 11 is a view similar to FIG. 5 according to another embodiment.

FIG. 12 is a partial cutaway view of the back carrier of FIG. 11, similar to FIG. 7.

FIG. 13A and FIG. 13B include FIG. 13A and FIG. 13B that are enlarged views of a part XIII of FIG. 12.

FIG. 14 is a view similar to FIG. 8 according to an embodiment.

FIG. 15 is a view similar to FIG. 8 according to an embodiment different from the embodiment of FIG. 14.

FIG. 16 is a view according to an embodiment different from the embodiment of FIG. 7.

FIG. 17 is a cross-sectional view taken along line XVII-XVII in FIG. 16.

FIG. 18 is a view according to an embodiment different from the embodiment of FIG. 17.

FIG. 19A is a partial cutaway perspective view of a top shape retaining member and a side shape retaining member in FIG. 17, and FIG. 19B is a partial cutaway perspective view of a top shape retaining member and a side shape retaining member in FIG. 18.

FIG. 20A to FIG. 20C are views of meandering states of a conduit.

### DESCRIPTION OF EMBODIMENTS

Referring to the accompanying drawings, details of the present invention are described below.

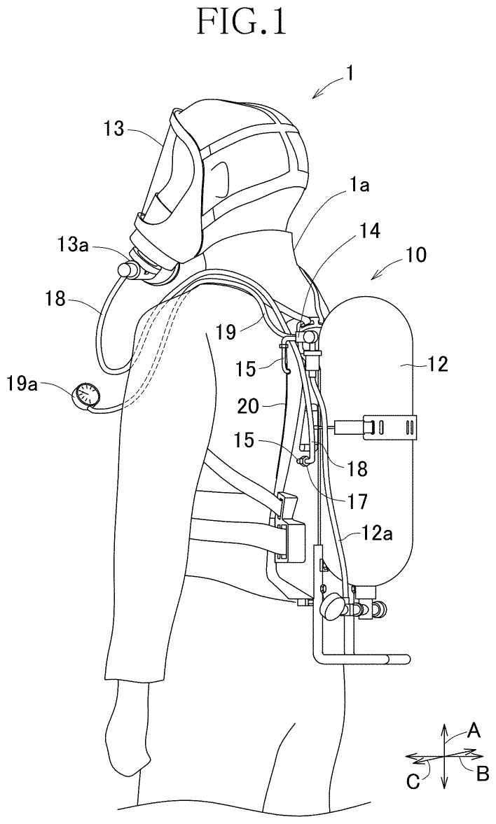

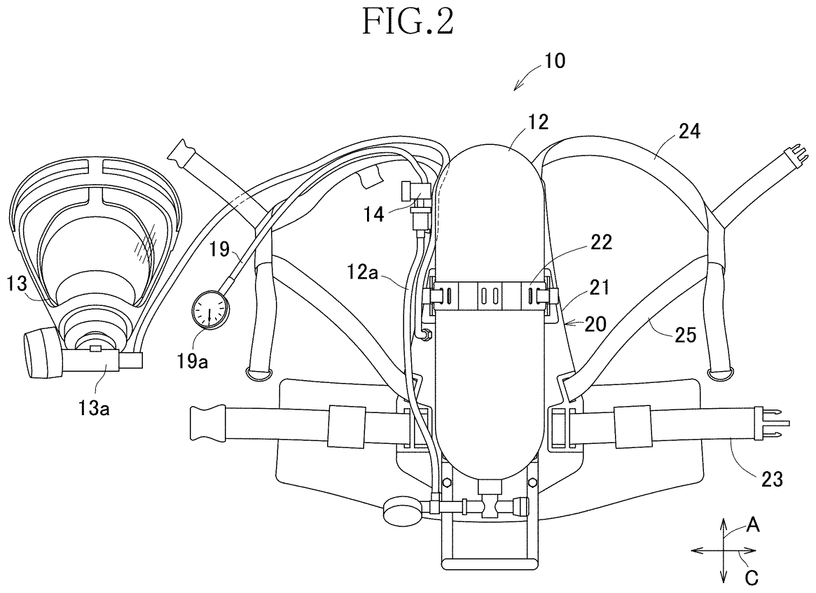

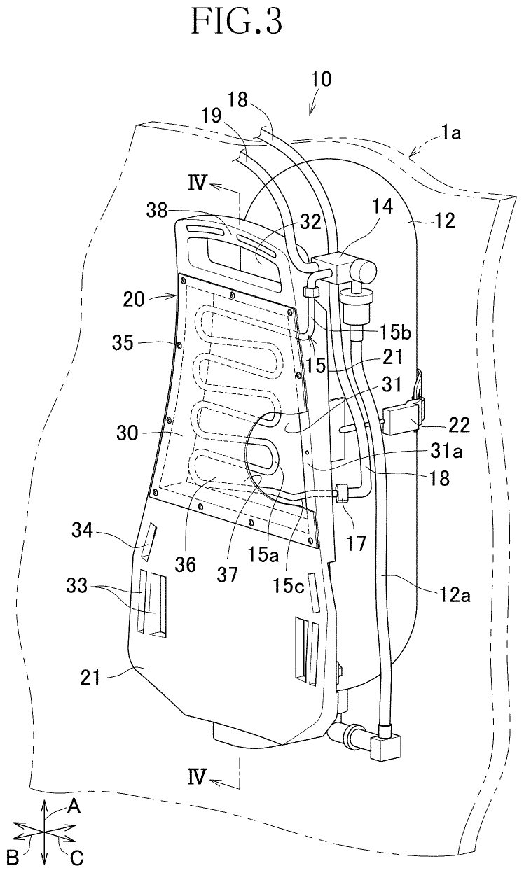

FIGS. 1 and 2 are, respectively, a perspective view of an air respirator 10 according to the present invention and a plan view of the air respirator 10, and the air respirator 10 in FIG. 1 is in a wearing state. The air respirator 10 includes a back carrier 20 to be fixed to the back of a wearer 1, a cylinder 12 to be fixed to the back carrier 20, and a facepiece 13 to be attached on the face of the wearer 1. The back carrier 20 has a longitudinal direction A, a front-rear direction B, and a lateral direction C respectively corresponding to a longitudinal direction, front-rear direction, and lateral direction of the wearer 1 (see FIG. 3). A high-pressure conduit 12a extends from the cylinder 12 to a branching port 14. The branching port 14 has a pressure reducing valve built in, and a conduit 15 made of metal extends from the pressure reducing valve. The conduit 15 extends to enter the back carrier 20 at an upper part of the back carrier 20. At a lower part of the back carrier 20, a lower portion 15c of the conduit 15 coming out of the back carrier 20 is connected to a medium-pressure hose 18 via a connector 17 (see FIG. 3). The medium-pressure hose 18 is commonly used in the relevant technical field and is connected to a supply valve 13a of the facepiece 13. A high-pressure hose 19 attached with a pressure gauge 19a also extends from the branching port 14. The high-pressure hose 19 is also commonly used in the relevant technical field.

In FIG. 2, the back carrier 20 includes a plate section 21 (see FIG. 3) to be put on the back of the wearer 1, and a quick-disconnect belt 22 used to fix the cylinder 12 to the plate section 21. In addition, the back carrier 20 can be worn using a waist belt 23, a shoulder belt 24, and a chest belt 25.

FIG. 3 is a partial cutaway perspective view of the air respirator 10, but the facepiece 13 and the pressure gauge 19a are omitted. The plate section 21 of the back carrier 20 is made of synthetic resin such as an ABS resin, or metal such as aluminum, and includes a first through hole 31 covered with a cooling plate 30, a second through hole 32 defining a handle section 38, a third through hole 33 for inserting the waist belt 23, and a fourth through hole 34 for inserting the chest belt 25. The plate section 21 may be made of foamed plastic for weight reduction. The cooling plate 30 is made of a plate material having a thermal conductivity of at least 2 W/m·K, preferably 10 W/m·K, or more preferably 100 W/m·K, and is attached to a peripheral section 31a of the first through hole 31 by a plurality of machine screws 35. The cooling plate 30 of the back carrier 20 is intended to make contact with the back of the wearer when the air respirator 10 is worn, and includes a front surface 36 facing the back of the wearer and a rear surface 37 opposite to the front surface 36. The conduit 15 is closely attached to the rear surface 37 in a meandering state, and forms a cooling conduit section 15a according to the present invention.

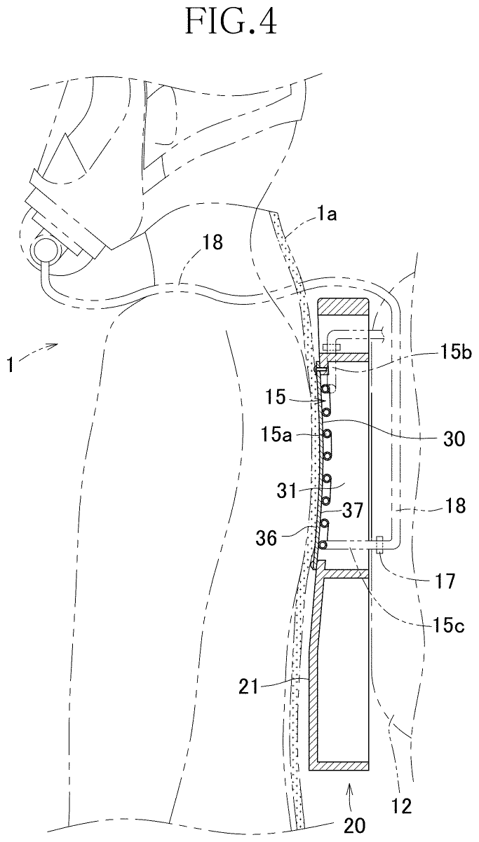

FIG. 4 is a cross-sectional view taken along line IV-IV of FIG. 3, but the wearer 1, the cylinder 12, the medium-pressure hose 18, and part of the conduit 15 are shown by imaginary lines. In FIG. 4, the cylinder 12 is fixed to the plate section 21 of the back carrier 20 to face the rear face 37. The cooling plate 30 attached to the plate section 21 covers the first through hole 31 in the plate section 21, and the front surface 36 of the cooling plate 30 is pressed against and in contact with the back of the wearer 1 through protective clothing 1a (see FIG. 1) that is clothing of the wearer 1. The conduit 15 extending from the pressure reducing valve of the branching port 14 enters the first through hole 31 by an upper portion 15b, meanders thereafter, and is closely attached to the rear surface 37 of the cooling plate 30 so as to form the cooling conduit section 15a. Although it is not shown, the conduit 15 is attached to the cooling plate 30 by metal fittings in appropriate shapes or adhesives, or by welding. At a lower part of the first through hole 31 in the plate section 21, the lower portion 15c of the conduit 15 comes out of the first through hole 31 to be connected to the medium-pressure hose 18 via the connector 17 serving as a joint.

As described above, in the air respirator 10 where the back carrier 20 includes the cooling plate 30 and the cooling conduit section 15a, breathable gas such as air is adiabatically expanded to drop its temperature when the gas filled in the cylinder 12 at high pressure flows out of the cylinder 12 to the conduit 15 via the pressure reducing valve of the branching port 14. In the process of passing through the cooling conduit section 15a, the gas cools not only the cooling conduit section 15a, but also the cooling plate 30 in close contact with the cooling conduit section 15a, and the air around the conduit 15 and the cooling plate 30. As a result, the wearer 1 wearing the air respirator 10 who is also a worker has his/her back or the like cooled, which can make it easy for the wearer to work on a task, and can provide a preventive effect of heatstroke as well. As shown in the drawings, the gas flows from a top to a bottom in the longitudinal direction A, so that the gas first cools upper parts of the cooling conduit section 15a and the cooling plate 30 and the air around the upper parts. The air cooled in such a manner spontaneously moves from the top to the bottom so as to cool the back of the wearer 1.

In the present invention, the cooling plate 30 can be made of a material such as a graphite sheet, an aluminum plate, a copper plate, or a stainless-steel plate. The thermal conductivities of these plate materials can be measured with a thermal conductivity analyzer TCi, type Classic-k or Basic-k of Rigaku Corporation, for example.

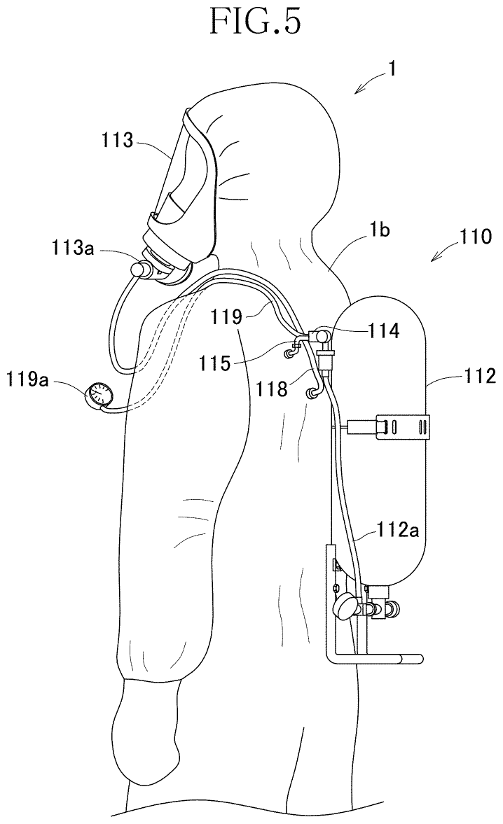

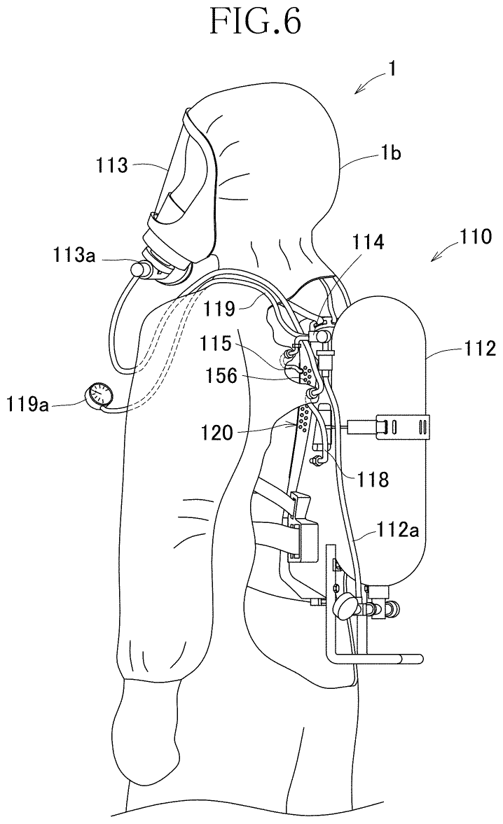

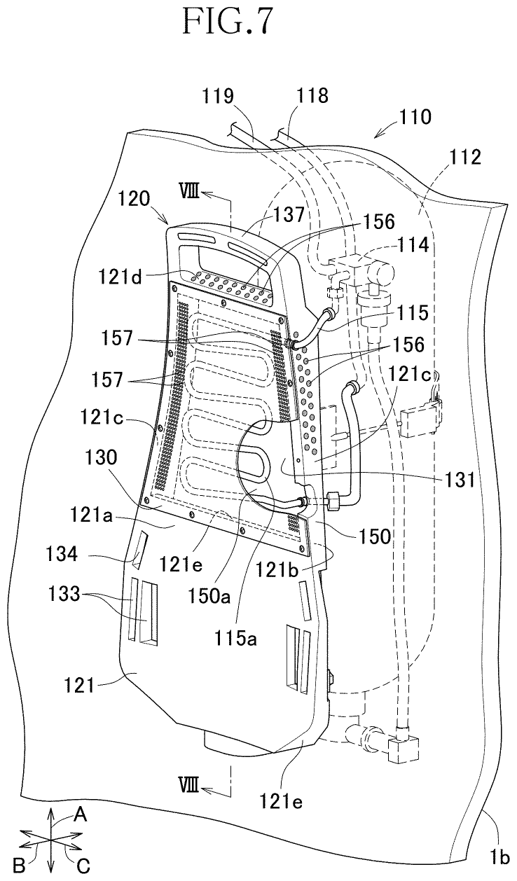

As for FIGS. 5 and 6, FIG. 5 is a view similar to FIG. 1 according to an embodiment of the present invention, and FIG. 6 is a partial cutaway view of FIG. 5. The wearer 1 in FIGS. 5 and 6 wears protective clothing 1b for entirely or mostly protecting the body of the wearer 1 from dust, for example, along with an air respirator 110 according to the present invention. The air respirator 110 includes a cylinder 112 and a back carrier 120 to which the cylinder 112 is fixed. However, the air respirator 110 is worn such that the cylinder 112 is disposed outside the protective clothing 1b and the back carrier 120 is disposed inside the protective clothing 1b (see FIG. 6). As apparent in FIG. 5, a high-pressure conduit 112a extending from the cylinder 112 and a branching port 114 attached to the high-pressure conduit 112a are disposed outside the protective clothing 1b, while a metal conduit 115 extending from the branching port 114 extends toward the inside of the protective clothing 1b and is then connected to a medium-pressure hose 118 inside the protective clothing 1b (see FIG. 7). The medium-pressure hose 118 comes out of the protective clothing 1b and extends to an intake valve 113a attached to a facepiece 113. A high-pressure hose 119 extending from the branching port 114 is disposed outside the protective clothing 1b, and has a residual pressure gauge 119a attached to an extended distal end.

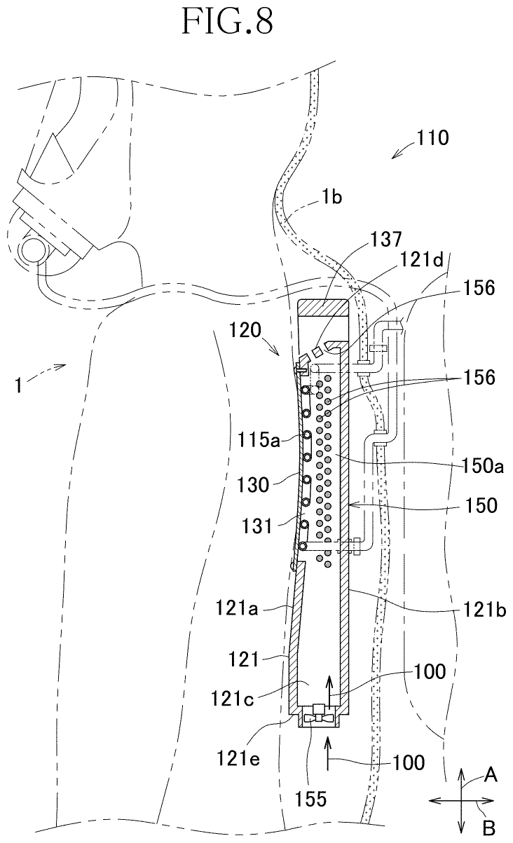

FIG. 7 is a partial cutaway view of the back carrier 120 disposed inside the protective clothing 1b in FIG. 6, but the wearer 1 in FIG. 6 is omitted and only part of the protective clothing 1b is shown. FIG. 8 is a cross-sectional view taken along line VIII-VIII of FIG. 7.

The back carrier 120 in FIGS. 7 and 8 includes a plate section 121 and a cooling plate 130. However, as apparent in FIG. 8, the plate section 121 is formed in a box shape unlike the plate section 21 in FIG. 4. That is, the plate section 121 includes a front plate 121a facing the back of the wearer 1 (see FIG. 5), a rear plate 121b separately facing the front plate 121a, both side plates 121c interposed between the front plate 121a and the rear plate 121b and facing each other in the lateral direction C of the wearer 1, and an upper plate 121d and a lower plate 121e facing each other in the longitudinal direction A of the wearer 1. The front plate 121a includes a first through hole 131. A handle section 137 is formed above the first through hole 131, and a plurality of through holes 133 for inserting the waist belt (not shown) and a fourth through hole 134 for inserting a chest belt (not shown) are formed below the first through hole 131. In such a plate section 121, the first through hole 131 is covered with the cooling plate 130 to define a cooling box 150 with the front plate 121a, rear plate 121b, side plates 121c, upper plate 121d, lower plate 121e, and cooling plate 130, and the cooling box 150 includes a hollow section 150a inside. The side plates 121c, upper plate 121d, and lower plate 121e integrally form a peripheral wall section of the plate section 121.

The cooling box 150 accommodates a cooling conduit section 115a formed of the meanderingly extending conduit 115, and the cooling conduit section 115a can be closely attached to the cooling plate 130 by a metal or plastic fastening member (not shown), or a joining means (not shown) such as adhesion or welding. However, the cooling conduit section 115a may be accommodated in the cooling box 150 without close contact with the cooling plate 130.

As apparent in FIG. 8, the back carrier 120 also includes at least one blower 155 attached to the lower plate 121e. The blower 155 can send the air outside the cooling box 150 into the cooling box 150 from below. Among members forming the cooling box 150, at least any one of the front plate 121a, side plates 121c, upper plate 121d, and lower plate 121e includes a plurality of exhaust holes 156. The cooling plate 130 also includes many exhaust holes 157 (see FIG. 7) aligned in the longitudinal direction.

In the air respirator 110 configured in such a manner, similar to the air respirator 10 in the embodiment in FIG. 1, the breathable gas is adiabatically expanded to drop its temperature when the gas filled in the cylinder 112 at high pressure flows out of the cylinder 112 and passes through the pressure reducing valve of the branching port 114. Accordingly, as the temperature of the cooling conduit section 115a drops, the temperature of the cooling plate 130 attached with the cooling conduit section 115a also drops, so that the cooling plate 130 can cool the back of the wearer 1. Moreover, air 100 inside the protective clothing 1b is blown into the cooling box 150 of the back carrier 120 from below by the blower 155, so that the air 100 is cooled by the cooling conduit section 115a and the cooling plate 130. The cooled air 100 goes out of the cooling box 150 through the many exhaust holes 156 and 157 communicating with the inside and the outside of the cooling box 150, and spreads all over a space between the protective clothing 1b and the wearer 1 so as to make the wearer 1 feel the cool air.

Furthermore, in the back carrier 120, the upper plate 121d slopes upward in a direction from the front plate 121a to the rear plate 121b. Accordingly, the cool air coming out of the plurality of exhaust holes 156 in the upper plate 121d can flow toward the neck of the wearer 1. This configuration of the back carrier 120 is preferable for making the wearer 1 feel the cool air.

Such an air respirator 110 can cool the back of the wearer 1 via the cooling plate 130 similarly to the air respirator shown in FIGS. 1 to 3, and can also cool body parts of the wearer 1 by the cooled air 100. Furthermore, circulating the air 100 in the protective clothing 1b can enhance the cooling effect on the air. However, the back carrier 120 in the air respirator 110 may exclude the cooling plate 130 and include the front plate 121a having approximately the same size as that of the rear plate 121b, unlike the embodiment shown in the drawings.

When the air respirator 110 shown in FIGS. 7 and 8 does not need the cooling effect produced by the cooling plate 130 and only needs the cooled air, the cooling plate 130 may be made of other plate materials having a low thermal conductivity, or may be integrally molded with the plate section 121 so as to be made of the same material as that of the plate section 121. Furthermore, the air respirator 110 may be implemented in an embodiment such that the cooling conduit section 115a does not make close contact with the cooling plate 130.

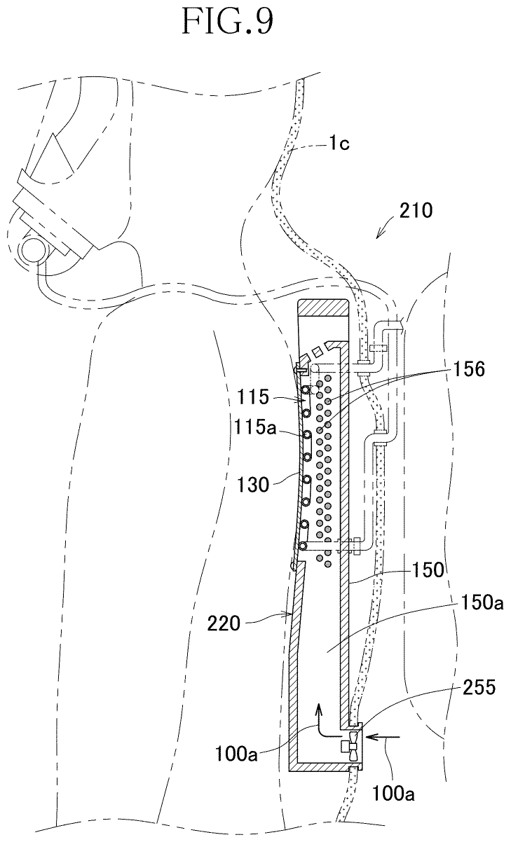

FIG. 9 is also a view similar to FIG. 8 according to an embodiment of the present invention. An air respirator 210 in FIG. 9 is also used with protective clothing 1c that entirely or mostly protects the body of the wearer 1, similarly to the air respirator 110 in FIG. 8. However, with this protective clothing 1c, a blower 255 used for the air respirator 210 is configured to send the air outside the protective clothing 1c, that is, outside air 100a into the cooling box 150 of a back carrier 220 in the air respirator 210. In other words, the air respirator 210 and the protective clothing 1c in FIG. 9 are used in an environment that sending the outside air 100a into the protective clothing 1c does not harm the wearer 1.

The embodiment in FIG. 9 differs from the embodiment in FIG. 8 only in usage of the blower 255. When the outside air 100a in a working environment of the wearer 1 is clean, the embodiment as shown in the drawing can efficiently supply the cool air to the wearer 1. In FIG. 9, portions identical to those in FIG. 8 are denoted by the same reference signs.

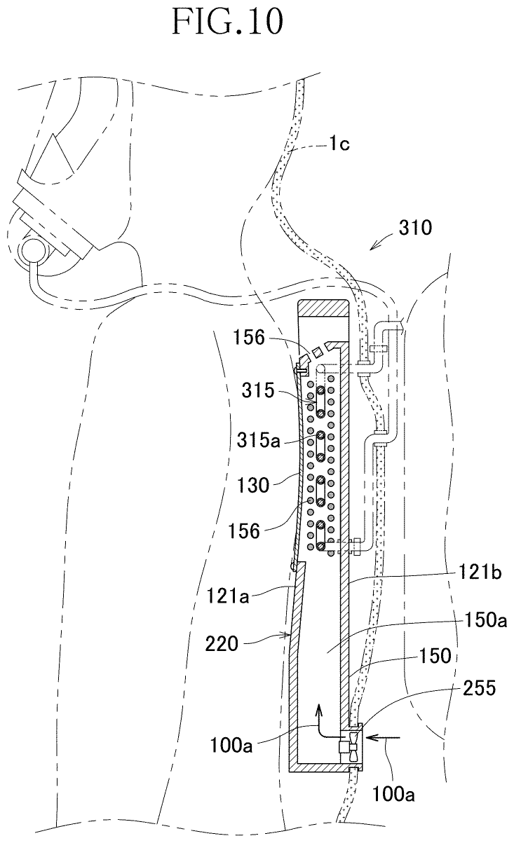

FIG. 10 is a view similar to FIG. 8 according to an embodiment of the present invention. An air respirator 310 in FIG. 10 includes the back carrier 220 and is used with the protective clothing 1c shown in FIG. 9. However, in the back carrier 220 in FIG. 10, a cooling conduit section 315a formed of a conduit 315 does not make contact with any of the cooling plate 130, front plate 121a, and rear plate 121b. The outside air 100a taken into the hollow section 150a of the back carrier 220 from the outside of the protective clothing 1c by the blower 255 makes contact with the cooling conduit section 315a to be cooled, goes out of the hollow section 150a after being cooled and can cool the body of the wearer 1. When the cooling plate 130 is made of a metal plate or a graphite sheet having a high thermal conductivity such as at least 2 W/m·K, the back of the wearer 1 can be cooled via the cooling plate 130. However, when it is enough to cool the outside air 100a taken in using the blower 255 by the cooling conduit section 315a, the back carrier 220 without the cooling plate 130 may be adopted. In the back carrier 220 in such a case, the front plate 121a has a size that can replace the cooling plate 130. The back carrier 220 may be made of any material, and may be entirely made of foamed plastic having a light weight and high heat insulation, for example.

As apparent from the embodiment of the back carrier 220 in FIG. 10, the back carrier 220 including the hollow section 150a and the plurality of exhaust holes 156 (see FIG. 7) formed in required parts functions as a distributer of the outside air 100a that can change the outside air 100a sent in by the blower 255 into the cool air, and discharge the cool air forward, upward, sideward, or the like of the back carrier 220. A location, size, shape, number per unit area, or the like of the exhaust holes 156 can be set as needed. As shown in FIGS. 8 and 9, when the outside air 100a is taken into the back carrier 120 and 220 and discharged inside the protective clothing 1b and 1c, the inside of the protective clothing 1b and 1c is at a positive pressure, and the air in the protective clothing 1b and 1c blows out from gaps between openings of sleeves and a neck of the protective clothing 1b and 1c and the body of the wearer 1, so that the cool air can be sent all over the body.

The air respirator according to the present invention as described above can be implemented in embodiments below.

(1) The back carrier has the longitudinal direction, and the cooled gas flows from the top to the bottom in the longitudinal direction in the cooling conduit section.
(2) At least part of the front plate section is formed of a cooling plate made of a material having a thermal conductivity of at least 2 W/m·K, and the cooling conduit section is either in a close contact state or in a separate state with respect to the cooling plate.
(3) The back carrier has the longitudinal direction, the cooled gas flows from the top to the bottom in the longitudinal direction in the cooling conduit section, and the air sent in by the blower flows from the bottom to the top in the longitudinal direction.

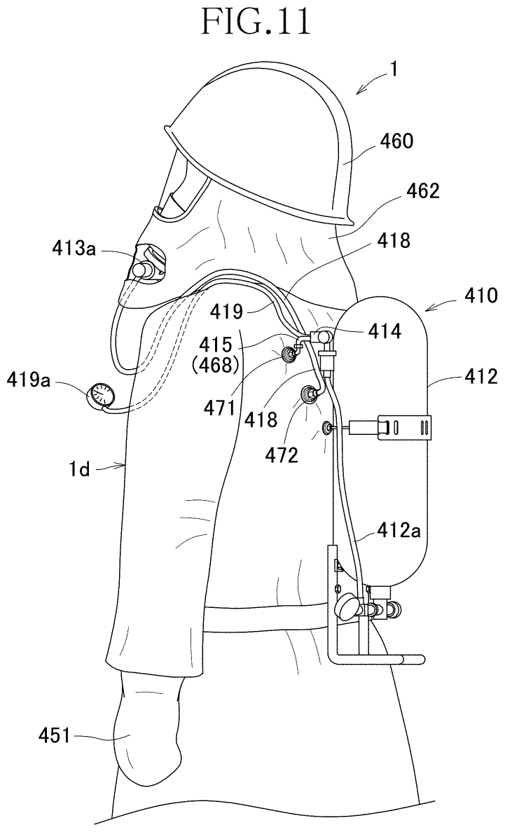

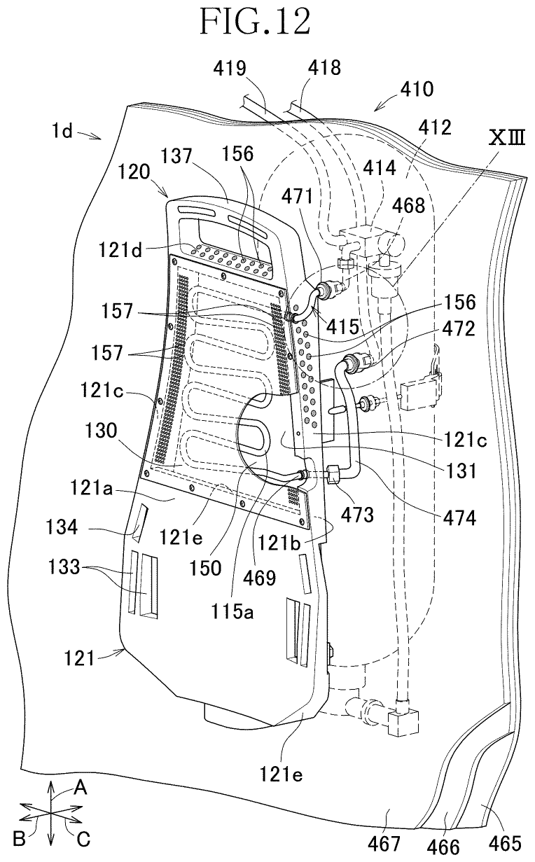

FIGS. 11, 12, and 13 are views according to an embodiment of the present invention where fireproof clothing 1d is used instead of the protective clothing 1b and 1c, and FIGS. 11 and 12 are views similar to FIGS. 5 and 7 except for the fireproof clothing 1d. An air respirator 410 in FIG. 11 is worn with the fireproof clothing 1d. The wearer 1 also wears individual fireproof equipment such as a fireproof helmet 460, fireproof gloves 451, fireproof shoes (not shown) in addition to the fireproof clothing 1d. A neck-protective garment 462 worn with the fireproof helmet 460 is partly cut away to show an intake valve 413a inside the neck-protective garment 462. A preferable example of the fireproof equipment satisfies a so-called self standard common in the relevant technical field. In FIG. 11, a high-pressure conduit 412a extending from a cylinder 412 extends up to a branching port 414. A conduit 415 containing the pressure-reduced, cooled breathable gas extends from the branching port 414 into the fireproof clothing 1d via a first joint member 471 attached to the fireproof clothing 1d.

In FIG. 12, the conduit 415 forming the cooling conduit section 115a inside the fireproof clothing 1d has its lower end portion 469 connected to an extension portion 474 of the conduit 415 via a joint member 473. The extension portion 474, which is practically part of the conduit 415, is connected to a medium-pressure hose 418 via a second joint member 472 attached to the fireproof clothing 1d, and the medium-pressure hose 418 extends up to the intake valve 413a (see FIG. 11). A pressure gauge 419a (see FIG. 11) is attached to a distal end of a high-pressure hose 419 extending from the branching port 414. In the conduit 415, a portion to be connected to the branching port 414 and the first joint member 471 is called a first end portion, while a portion to be connected to the medium-pressure hose 418 and the second joint member 472 is called a second end portion. The first end portion and the second end portion are respectively connected to the first joint member 471 and the second joint member 472 so as to penetrate the fireproof clothing 1d in a practical meaning. In the conduit 415 in the drawings, an upper end portion 468 forms the first end portion, and the extension portion 474 forms the second end portion.

In FIG. 12, portions having the same structures as those of the back carrier 120 in FIG. 7 are denoted by the same reference signs as those in FIG. 7. The fireproof clothing 1d in FIG. 12 includes an outer material 465 forming the outer layer, a moisture-permeable waterproof layer 466 forming the intermediate layer, and a heat insulating layer 467 forming the inner layer. For example, the outer material 465 is made of a woven fabric using a fiber such as an aramid fiber having excellent flame resistance, heat resistance, and mechanical strength. The moisture-permeable waterproof layer 466 is made of a woven fabric using a fiber such as polytetrafluoroethylene (PTFE) having excellent waterproofness and moisture permeability. The heat insulating layer 467 is made of a woven fabric using a fiber similar to the fiber used for the outer material, and including many air layers.

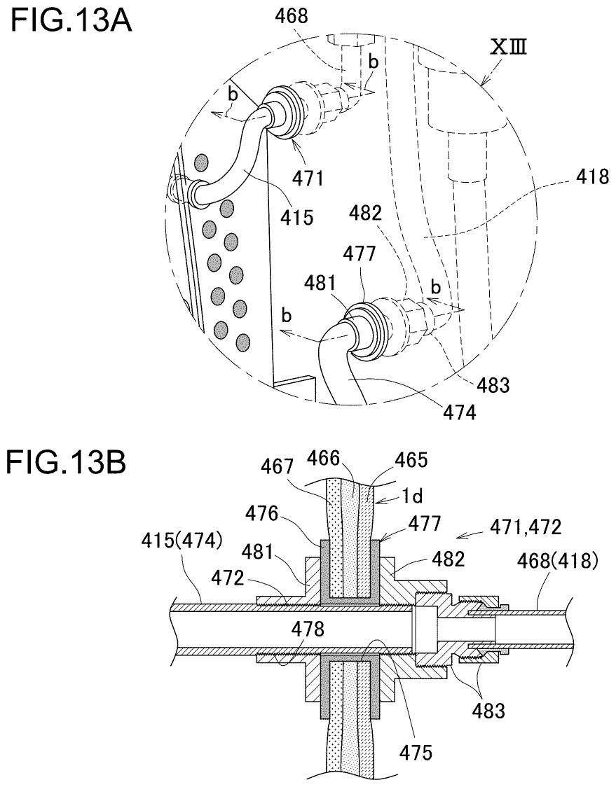

As for FIG. 13A to FIG. 13B, FIG. 13A is an enlarged view of a portion XIII of FIG. 12, and FIG. 13B is an arrow view of the first and second joint members 471 and 472 taken in a direction of line b-b of FIG. 13A. The first joint member 471 and the second joint member 472 in the drawings have an identical shape and an identical attaching structure to the fireproof clothing 1d. In FIG. 13B, the fireproof clothing 1d including the outer material 465, the moisture-permeable waterproof layer 466, and the heat insulating layer 467 includes a through hole 475 penetrating these three layers 465, 466, and 467, and a ring member 477 including a flange portion 476 is attached to the through hole 475. A thread portion 478 is formed on an outer peripheral surface of each of the upper end portion 468 serving as the first end portion and the extension portion 474 serving as the second end portion of the conduit 415 penetrating the ring member 477, and the thread portion 478 screws together to an inner fastening member 481 and an outer fastening member 482 at the inside and outside of the fireproof clothing 1d, so that the inner fastening member and the outer fastening member make pressure contact with the flange portion 476 of the ring member 477. The outer fastening member 482 is connected with the upper end portion 468 of the conduit 415 or the medium-pressure hose 418 via a set of coupling members 483 that screws to the outer fastening member 482. As shown in the drawings, the fireproof clothing 1d includes the through hole 475, and the air respirator 410 is used utilizing the through hole 475. However, when the through hole 475 is used in accordance with the embodiment in the drawings, an air tight state between the inside and outside of the fireproof clothing 1d is maintained around the through hole 475, and thus hot blast at fire sites or the like can be prevented from entering the fireproof clothing 1d via the through hole 475. According to the present invention, in the air respirator 410 and the fireproof clothing 1d shown in FIGS. 11 to 13, members to be disposed outside the fireproof clothing 1d are made of materials having excellent incombustibility, flame resistance, and heat resistance so that the fireproof clothing 1d can fully function.

In the present invention described above, the conduit 15, 115, and 415, and other portions in the air respirator 10, 110, 210, and 410 can be used in a state of being covered with a heat insulating material, an incombustible material, a flame resistant material, or the like.

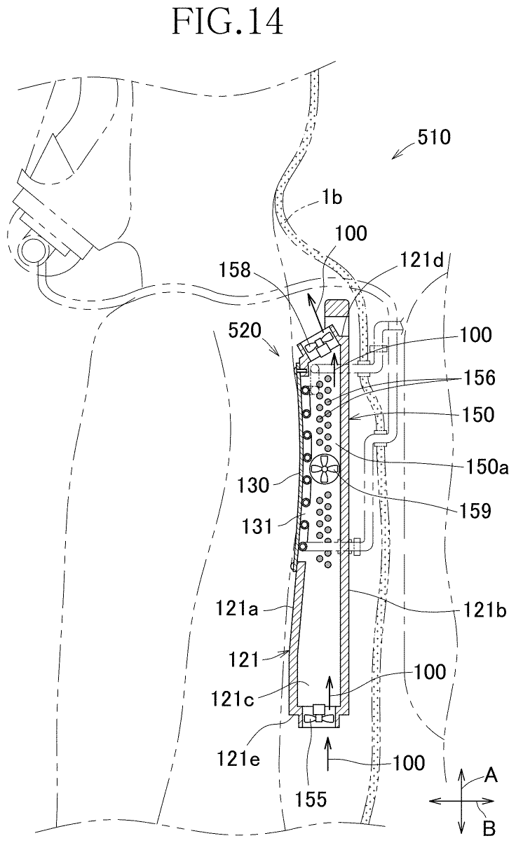

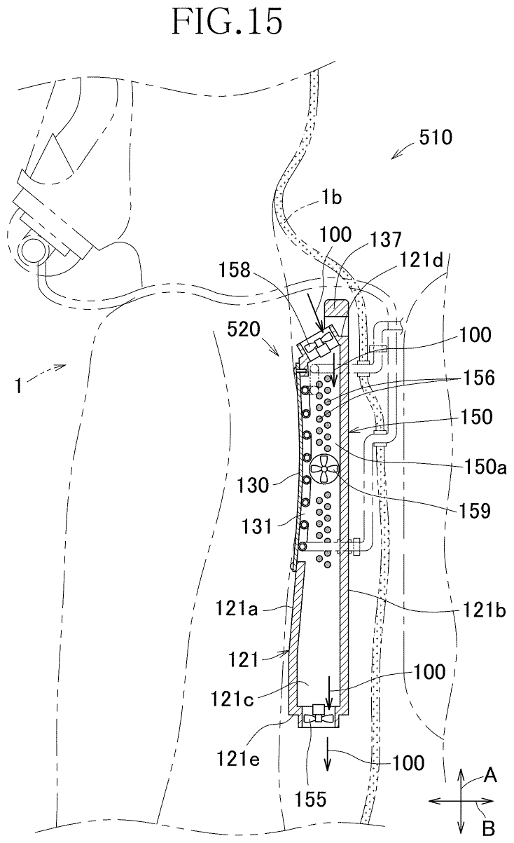

FIGS. 14 and 15 are views similar to FIG. 8 according to an embodiment of the present invention. A back carrier 520 in FIG. 14 includes exhaust blowers 158 and 159 on the upper plate 121d and both the side plates 121c of the cooling box 150, respectively. However, FIG. 14 shows only one side plate 121c of both the side plates 121c. In addition, an intake blower 155, shown in FIG. 8, is attached to the lower plate 121e of the cooling box 150. The plurality of exhaust holes 156, shown in FIGS. 7 and 8, are also formed in the upper plate 121d and both the side plates 121c. With the intake blower 155 and the exhaust blowers 158 and 159 in operation, the air 100 inside the protective clothing 1b easily flows in the cooling box 150 to be cooled, and the cooled air 100 easily flows out by an action of the exhaust blowers 158 and 159. An amount, speed, or the like of the wind in such an inflow and an outflow of the air 100 can be controlled by changing rotational speeds of the intake blower 155 and the exhaust blowers 158 and 159, and also by adequately setting a diameter of each exhaust hole 156 or a number of exhaust holes 156 in the upper plate 121d and both the side plates 121c. A number and installation positions of the intake blower 155 and the exhaust blowers 158 and 159 are not particularly restricted in the back carrier 520.

The back carrier 520 in FIG. 15 is configured similarly to the back carrier 520 in FIG. 14. However, in FIG. 15, the blower 155 is used as the exhaust blower while the blowers 158 and 159 are used as the intake blowers, and the air 100 inside the protective clothing 1b flows in a direction shown by the arrow. The back carrier 520 can also be used in such an embodiment. In the back carrier 520 in this case, the plurality of exhaust holes 156 may function as intake holes. Furthermore, it is possible to adopt an embodiment such that the cooling box 150 of the back carrier 520 includes the intake blower and the exhaust blower, but is not provided with the exhaust holes 156. The cooling box 150 using the plurality of exhaust holes 156 as the intake holes may include only the exhaust blower. In such a case, any of the blowers 155, 158, and 159 may be used as the exhaust blower, but the blower 158 used in a manner shown in FIG. 14 is particularly preferable.

Furthermore, although it is not shown, the air respirator 210 and 310 in FIGS. 9 and 10 may also include the exhaust blower disposed at an adequate position of the back carrier 220, and the number of exhaust holes 156 may be increased, decreased or set at zero as appropriate. Including such embodiments, the air respirators 110, 210, 310, 410, and 510 shown in FIGS. 5 to 15 can be implemented so as to include the cooling box, and at least two of three ventilation elements including the ventilation hole, the intake blower, and the exhaust blower that can be used for discharging or taking the air from/in the cooling box.

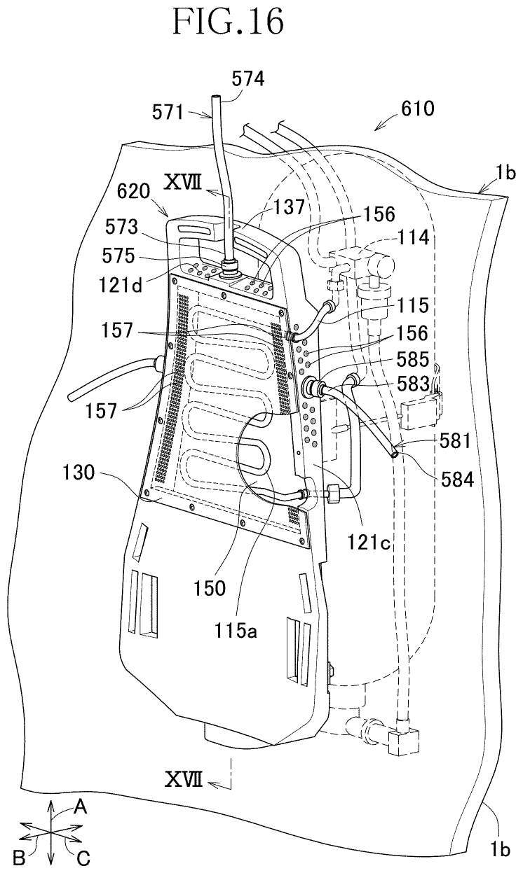

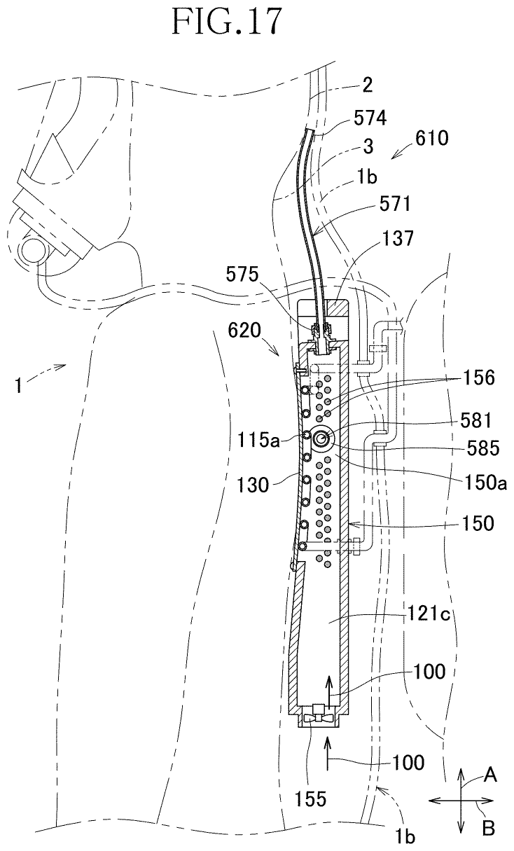

FIGS. 16 and 17 are views similar to FIGS. 7 and 8 according to an embodiment of the present invention. A back carrier 620 of an air respirator 610 in the drawings is configured similarly to the back carrier 120 in FIGS. 7 and 8, and portions identical to those of the back carrier 120 are denoted by the same reference signs as those of the back carrier 120. However, the back carrier 620 differs from the back carrier 120 in that the back carrier 620 includes a top shape retaining member 571 and side shape retaining members 581. The top shape retaining member 571 and the side shape retaining members 581 are disposed at different positions of the back carrier 620, but may have an identical shape or different shapes.

The top shape retaining member 571 is disposed on top of the back carrier 620, and has a base portion 573 attached to the upper plate 121d of the back carrier 620 by a fixing member 575. The top shape retaining member 571 also extends upward from the top plate 121d, and a distal end portion 574 is disposed between a back of the head 2 and/or neck 3 (see FIG. 17) of the wearer 1 and the protective clothing 1b, so that the top shape retaining member 571 can prevent the protective clothing 1b from touching the back of the head 2 or the neck 3, and create ventilation gaps between the protective clothing 1b and the back of the head 2 or the neck 3 so as to function as a shape retaining member with respect to the protective clothing 1b.

Each of the side shape retaining members 581 has a base portion 583 fixed to either of the side plates 121c by a fixing member 585. The side shape retaining member 581 also has a distal end portion 584 extending up to a vicinity of a side portion of the back of the wearer 1 such as a side of a torso, so that the side shape retaining member 581 can prevent the protective clothing 1b from touching underwear or skin (both not shown) of the wearer 1, and create ventilation gaps between the protective clothing 1b and the underwear or the like so as to function as a shape retaining member with respect to the protective clothing 1b.

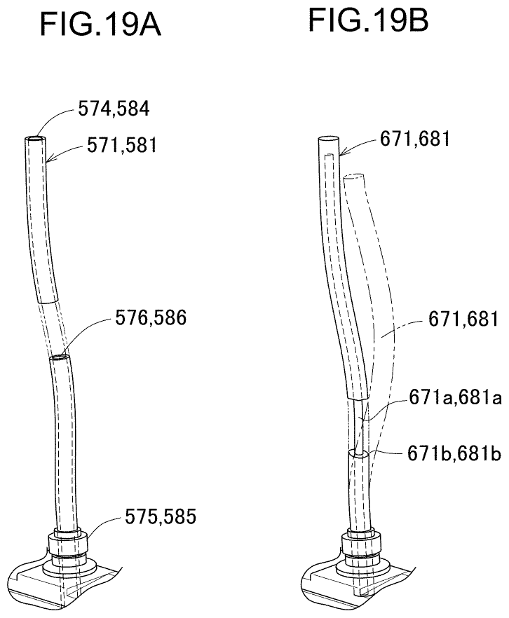

The top shape retaining member 571 and the side shape retaining member 581 are each made of a hollow member having a ventilation passage 576 or 586 (see FIG. 19A) such as a tubular member. Accordingly, the air in the hollow section 150a in the cooling box 150 of the back carrier 520 such as the air cooled by the cooling conduit section 115a or the cooling plate 130 can be discharged from the distal end portions 574 and 584 of the top shape retaining member 571 and the side shape retaining members 581 by the action of the blower 155. The air discharged in such a manner can reach as far as parts of the wearer 1 where the air discharged from the plurality of exhaust holes 156 and 157 (see FIG. 16) of the cooling box 150 can hardly reach. At the same time, this can locally cool the wearer 1. Furthermore, presence of the top shape retaining member 571 and the side shape retaining members 581 prevents the close contact between the body or underwear of the wearer 1 and the protective clothing 1b. As a result, the ventilation gaps are created between the body or the underwear and the protective clothing 1b, which can make the wearer 1 feel more comfortable when the wearer 1 works in the protective clothing 1b. However, the protective clothing 1b may include only one of the top shape retaining member 571 and the side shape retaining member 581, or a plurality of ones of the top shape retaining member 571 and the side shape retaining member 581.

The top shape retaining member 571 and the side shape retaining member 581 functioning in such a manner have no limitation on dimensions in a length direction and a radial direction, and shapes can be set freely. The top shape retaining member 571 and the side shape retaining member 581 are each preferably made of a synthetic resin material or the like having required heat resistance, flame resistance, or incombustibility. However, this does not specify a type of the material, and the material can be selected according to the work dealt with by the wearer in the protective clothing 1b. For example, it is possible to use a heat resistant rubber hose having appropriate flexibility, or an aluminum pipe with a surface covered with soft foamed synthetic resin or the like having low thermal conductivity. In the back carrier 620 including the top shape retaining member 571 and/or the side shape retaining member 581, presence or absence of the exhaust holes 156 and exhaust holes 157, and sizes and numbers per unit area of the exhaust holes 156 and exhaust holes 157, if present, can be adequately designed in consideration of working effects of the top shape retaining member 571 and the side shape retaining member 581. An example designed in such a manner includes the side shape retaining member 581 disposed only on one of the side plates 121c.

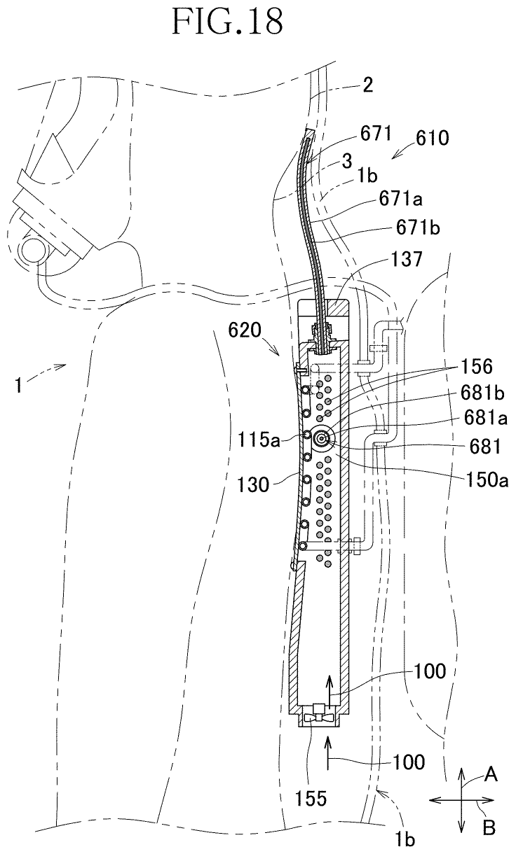

FIG. 18 is a view similar to FIG. 17 according to an embodiment including a top shape retaining member 671 and side shape retaining members 681 different from the top shape retaining member 571 and the side shape retaining members 581 in FIGS. 16 and 17. The top shape retaining member 671 and the side shape retaining members 681 in FIG. 18 are attached to the back carrier 620 similarly to the top shape retaining member 571 and the side shape retaining members 581 in FIG. 16. However, the top shape retaining member 671 and the side shape retaining members 681 differ from the top shape retaining member 571 and the side shape retaining members 581 in FIGS. 16 and 17 in that the top shape retaining member 671 and each of the side shape retaining members 681 respectively include flexible core materials 671a and 681a capable of maintaining a bent state in an adequate shape, and flexible covering materials 671b and 681b capable of deforming to follow the core material 671a, and do not include an air-permeable hollow section. Such a top shape retaining member 671 and side shape retaining member 681 can be easily adjusted in shape and direction of bending according to sizes of the wearer 1 and the protective clothing 1b, or a taste of the wearer 1. The core material 671a of the top shape retaining member 671 functioning in such a manner can be made of a flexible stick material of aluminum or the like. The covering material 671b can be made of flexible rubber, foamed polyurethane, bulky fabric, or the like. The side shape retaining member 681 can be made similarly to the top shape retaining member 671. The top shape retaining member 671 and the side shape retaining members 681 in FIG. 18 are preferred examples. The top shape retaining member 671 and the side shape retaining member 681 may include only the core materials 671a and 681a without the covering materials 671b and 681b. Moreover, the top shape retaining member 671 and the side shape retaining member 681 may be non-deformable, if necessary. In addition, the embodiment in FIG. 18 does not imply that the top shape retaining member 571 and the side shape retaining members 581 in FIGS. 16 and 17 can not maintain the bent state in an adequate shape.

FIG. 19A and FIG. 19B are partial cutaway perspective views of the top shape retaining member and the side shape retaining member. FIG. 19A shows the top shape retaining member 571 and the side shape retaining member 581 used for the back carrier 620 in FIGS. 16 and 17, and FIG. 19B shows the top shape retaining member 671 and the side shape retaining member 681 in FIG. 18. In FIG. 19A, the top shape retaining member 571 and the side shape retaining member 581 are air-permeable, and respectively include the ventilation passages 576 and 586. In FIG. 19B, the top shape retaining member 671 and the side shape retaining member 681 are not air-permeable, and respectively include the core materials 671a and 681a and the covering materials 671b and 681b. The top shape retaining member 571 and 671 and the side shape retaining member 581 and 681 according to the present invention can be used for the fireproof clothing in addition to the protective clothing 1b.

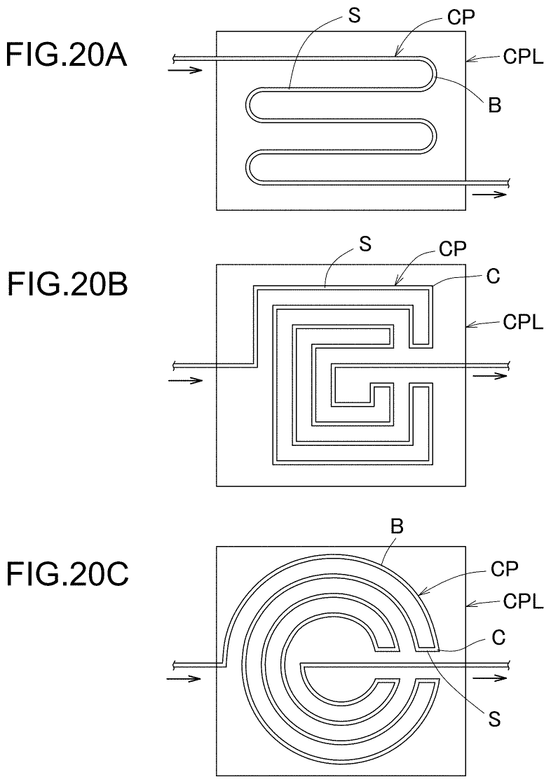

FIG. 20A to FIG. 20C show meandering states of a conduit CP that can be adopted for forming the cooling conduit section 15a, 115a, 315a, and 415a shown in the drawings according to the present invention, and a cooling plate CPL to which the conduit CP can be attached. In FIG. 20A, the conduit CP meanderingly extends while alternately repeating a linearly extending portion S and a curvingly extending portion B. In FIG. 20B, the conduit CP for cooling meanderingly extends while alternately repeating the linearly extending portion S and a bent portion C. In FIG. 20C, the conduit CP meanderingly extends while repeating in turn the curvingly extending portion B, the bent portion C, and the linearly extending portion S. According to the present invention, shapes of the linearly extending portion S, curvingly extending portion B, and bent portion C shown in the drawings can be combined in any way. The combination can be determined in consideration of an area or a length of contact between the conduit CP and the cooling plate CPL, or a degree of difficulty for bending the conduit CP. The cooling plate CPL is preferably made of a material having high thermal conductivity so as to be easily cooled via the conduit CP. Such a material includes a metal plate, or, in a broad meaning, a plate material having a thermal conductivity of at least 2 W/m·K A graphite sheet is one of such plate materials.

1. An air respirator comprising:
a cylinder containing breathable gas filled at high pressure;
a back carrier;
a pressure reducing valve; and
a flexible medium-pressure hose,
the back carrier, pressure reducing valve, and medium-pressure hose being used for the cylinder,
wherein the back carrier includes a cooling conduit section where the gas coming from the cylinder and adiabatically expanded via the pressure reducing valve flows in a meandering conduit made of metal to exert a cooling effect around the conduit, and the cooling conduit section is interposed between the pressure reducing valve and the medium-pressure hose.

2. The air respirator according to claim 1, wherein the conduit forming the cooling conduit section meanders by repeating any two or more of shapes including a curved shape, a bent shape, and a linear shape, and is in close contact with a cooling plate made of a material having a thermal conductivity of at least 2 W/m·K.

3. The air respirator according to claim 2, wherein the cooling plate includes a front surface configured to face the back of a wearer of the air respirator and a rear surface opposite to the front surface, and the cooling conduit section is in close contact with the rear surface.

4. The air respirator according to claim 3, wherein the back carrier is disposed inside protective clothing worn by the wearer.

5. The air respirator according to claim 1,
wherein the back carrier is disposed inside protective clothing worn by a wearer of the air respirator, and includes a cooling box including a front plate section configured to face the back of the wearer, a rear plate section configured to face a back part of the protective clothing, a peripheral wall section interposed between the front plate section and the rear plate section, and a hollow section defined at least by the front plate section, the rear plate section, and the peripheral wall section, and
wherein the cooling box includes at least two of ventilation elements including a ventilation hole, an intake blower, and an exhaust blower that are configured to allow ventilation between an inside and an outside of the hollow section accommodating the cooling conduit section so that air at one of an inside and an outside of the protective clothing is allowed to flow into the hollow section.

6. The air respirator according to claim 5, wherein the cooling box includes the ventilation hole and the intake blower, and when the intake blower is in operation, the air at one of the inside and the outside of the protective clothing flows into the cooling box while the air inside the cooling box flows out toward the inside of the protective clothing through the ventilation hole.

7. The air respirator according to claim 5, wherein the cooling box includes the ventilation hole and the exhaust blower, and when the exhaust blower is in operation, the air inside the cooling box flows out while the air inside the protective clothing flows into the cooling box through the ventilation hole.

8. Fireproof clothing worn with the air respirator according to claim 1,
wherein the conduit including the cooling conduit section is interposed between the pressure reducing valve and the medium-pressure hose, and includes a first end portion connected to the pressure reducing valve and a second end portion connected to the medium-pressure hose,
wherein the fireproof clothing includes an outer layer, an inner layer, and an intermediate layer interposed between the outer layer and the inner layer, the cylinder is disposed outside the outer layer, and the back carrier and the cooling conduit section are disposed inside the inner layer, and
wherein the first end portion and the second end portion substantially penetrate the fireproof clothing.

9. The fireproof clothing according to claim 8,
wherein the cooling conduit section meanders by repeating any two or more of shapes including a curved shape, a bent shape, and a linear shape, and is in close contact with a cooling plate made of a material having a thermal conductivity of at least 2 W/m·K,
wherein the cooling plate is disposed inside the inner layer and includes a front surface configured to face the back of a wearer of the air respirator and a rear surface opposite to the front surface, and
wherein the cooling conduit section is in close contact with the rear surface.
